(19) United States
(12) Patent Application Publication
(10) Pub. No.: US 2026/0255044 A1
(43) Pub. Date: Aug. 27, 2026

(54) Stovetop WiFi Camera and Software Application Device

(71) Applicant: Danielle Barron, Litchfield Park, AZ (US)

(72) Inventor: Danielle Barron, Litchfield Park, AZ (US)

(21) Appl. No.: 19/213,187

(22) Filed: May 20, 2025

Related U.S. Application Data
(60) Provisional application No. 63/761,396, filed on Feb. 21, 2025.

(51) Int. Cl. H04N 7/18; F24C 15/00; H04N 23/50; H04N 23/56

(52) U.S. Cl. CPC H04N 23/56; H04N 23/555; F24C 15/00

(57) ABSTRACT

A stovetop camera application device is disclosed, which is a stovetop Wi-Fi enabled camera system and corresponding software application. The stovetop camera application device comprises a heat-resistant camera component with a wide-angle lens that operates in a normal image mode or a heat camera mode. The camera component is installed above a stovetop hood or is wall mounted via magnets and angled brackets. The camera component includes sensors to detect methane gas or smoke. The corresponding software application has customizable features, such as alarms for flame detection, steam alerts, boiling notifications, and timers to enhance functionality and safety.

### CROSS-REFERENCE TO RELATED APPLICATION

The present application claims priority to, and the benefit of, U.S. Provisional Application No. 63/761,396, which was filed on Feb. 21, 2025, and is incorporated herein by reference in its entirety.

### FIELD OF THE INVENTION

The present invention relates generally to the field of stovetop camera application devices. More specifically, the present invention relates to a stovetop Wi-Fi camera with a corresponding software application to virtually watch cookware on a stove. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in stovetop camera application devices. Generally, when cooking, individuals often have multiple things to do, and standing by the stove to check the food or to see if there is an issue is inconvenient, time-consuming, and can become frustrating. Thus, a watched pot never boils, and waiting around for it wastes time too.

Accordingly, there is a demand for an improved stovetop camera application device that allows users to virtually watch cookware on a stove. More particularly, there is a demand for a stovetop camera application device that includes a heat-resistant camera with a wide-angle lens and a corresponding software application to allow users to monitor their cooking remotely via a smart device and receive notifications of boiling alerts, flame detection, or steam alerts.

Therefore, there exists a long-felt need in the art for a stovetop camera application device that allows a user to virtually watch cookware on a stove. There is also a long-felt need in the art for a stovetop camera application device that utilizes a corresponding software application to watch cookware on a stove and receive notifications. Further, there is a long-felt need in the art for a stovetop camera application device that includes a heat-resistant camera with a wide-angle lens and brackets for mounting the camera. Moreover, there is a long-felt need in the art for a device that includes sensors to detect methane gas or smoke and send alerts. Further, there is a long-felt need in the art for a stovetop camera application device that includes a customizable software application which allows a user to set alarms for flame detection, steam alerts, and boiling notifications. Finally, there is a long-felt need in the art for a stovetop camera application device that includes timers to enhance functionality and safety.

The subject matter disclosed and claimed herein, in one embodiment thereof, comprises a stovetop camera application device. The device is a stovetop Wi-Fi enabled camera system and corresponding software application. The stovetop camera application device comprises a heat-resistant camera component with a wide-angle lens that operates in a normal image mode or a heat camera mode. The camera component is installed above a stovetop hood or is wall mounted via magnets and angled brackets. The camera component includes sensors to detect methane gas or smoke. The corresponding software application has customizable features, such as alarms for flame detection, steam alerts, boiling notifications, and timers to enhance functionality and safety.

In this manner, the stovetop camera application device of the present invention accomplishes all of the foregoing objectives and provides users with a device that allows a user to monitor their cooking remotely. The device includes a camera component with a corresponding software application. The device can be operated in a normal image mode or a heat camera mode.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a stovetop camera application device. The device is a stovetop Wi-Fi enabled camera system and corresponding software application. The stovetop camera application device comprises a heat-resistant camera component with a wide-angle lens that keeps the whole cooktop in view. The camera component is installed above a stovetop and includes sensors to detect methane gas or smoke. The corresponding software application has customizable features.

In one embodiment, the stovetop camera application device allows for remote viewing of the kitchen from anywhere in the house via a convenient linked app. A watched pot never boils, and waiting around for it wastes time too. The stovetop camera application device makes it simple to monitor the state of the stovetop, via the paired camera component and sensors with multiple wireless streaming options.

In one embodiment, the stovetop camera application device comprises a heat-resistant camera component with a wide-angle lens. The camera component can be a standard, off-the-shelf camera component and can be equipped with a light which is triggered when the ambient light is less than a threshold. Typically, the camera component is a heat-resistant camera, such as a thermal and/or infrared camera, which obtains thermal images, but can be any suitable camera as is known in the art.

In one embodiment, the camera component includes a clear adhesive camera protector. The clear adhesive camera protector is secured over the wide-angle lens and the front of the camera component to protect it from splashes, steam, moisture, and condensation from the food cooking on the stovetop. The clear adhesive camera protector is similar to a screen protector for a smartphone and can be applied and replaced with a new protector as needed.

In one embodiment, the camera component is mounted above the stovetop or directly near it and angled in such a way that the stovetop can be viewed via the camera component and its wide-angle lens. Further, the camera component can be mounted on the stove hood or on the wall behind the stove. Specifically, the camera component can be mounted directly to an underside of the stove hood via magnets or adhesive, or any other suitable releasably securing means as is known in the art. Further, the camera component is mounted directly above the stovetop against a wall via a mounting bracket. The mounting bracket is an L-shaped bracket with the bracket coupled together via a hinge. Specifically, the mounting bracket would be secured to a wall via double sided tape, adhesive, or screws, etc., or any other suitable securing means as is known in the art. The camera component is then secured to the mounting bracket via magnets or adhesive, etc., or any other suitable releasably securing means as is known in the art. Further, the hinge of the mounting bracket can click to a specific angle and is easily adjusted to various angles and then holds the camera component at that angle, such that the camera component can view the entire stovetop with its wide-angle lens.

Of course, the number, placement, and coverage area of the camera component will usually vary depending on such factors as the size and location of the stovetop, the size of the stove hood, the location of windows, and the surrounding area etc.

In one embodiment, the camera component can be operated in two different modes, such as normal image mode and heat camera mode. The camera component can be switched between the modes, as needed. The normal image mode records and sends a regular image of the food cooking on the stovetop to the smartphone display. The heat camera mode records and sends a thermal image of the food cooking on the stovetop, showing a gradient of how hot or cold the food is on the smartphone display.

In one embodiment, the camera component comprises methane gas and smoke sensors. These sensors detect flames, fires, steam alerts, boiling notifications, etc., that can occur on the stovetop.

In one embodiment, the camera component comprises a light, which can be tapped to illuminate the stovetop. The light can be a standard LED bulb or any other suitable light bulb as is known in the art. Further, the light can be manually activated via being tapped to illuminate, on a timer, triggered when the ambient light is less than a threshold, or activated by a motion sensor.

In one embodiment, the stovetop camera application device pairs with a user's smartphone via Wi-Fi or Bluetooth, or other wireless streaming options, notifying users and providing them with a livestream video feed of the stovetop. Specifically, the stovetop camera application device comprises a software application which is utilized by a user to control the device. Thus, the device is designed to be controlled by and/or provide data to a handheld telecommunications unit, such as a smartphone, through the software application. Users can use the software application to view a livestream video feed of the stovetop, send notifications, and/or receive alerts etc. Specifically, the software application can have customizable features, such as alarms for flame detection, steam alerts, boiling notifications, and timers to enhance functionality and safety, etc., and any other suitable alerts and/or notifications as is known in the art.

In one embodiment, the stovetop camera application device includes a wireless communications module and additional sensors, which would allow the device to pair with the software application on the smart device. Once paired, a user could control the stovetop camera application device via the software application. In one embodiment, the smart device may be a smartphone, a tablet, a laptop, or a desktop computer, etc., or any other suitable electronic device that has the required operating and memory parameters to support the software application of the present invention and may be connected to the internet. The smart device may perform any type of wireless communication, including, but not limited to, WIFI, BLUETOOTH, RFID, NFC, etc.

In yet another embodiment, the stovetop camera application device comprises a plurality of indicia.

In yet another embodiment, a method of remotely monitoring items being cooked on a stovetop is disclosed. The method includes the steps of providing a stovetop camera application device comprising a camera component with a corresponding software application. The method also comprises mounting the camera component above a stovetop for use. Further, the method comprises pairing a smart device with the camera component. The method also comprises remotely monitoring items being cooked on the stovetop via the smart device. Finally, the method comprises receiving notifications and alerts via the paired smart device of flame detection, steam alerts, boiling notifications, and timers.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the stovetop camera application device of the present invention in accordance with the disclosed architecture;

FIG. 2 illustrates a perspective view of one embodiment of the stovetop camera application device of the present invention showing the components of the invention in accordance with the disclosed architecture;

FIG. 3 illustrates a perspective view of one embodiment of the stovetop camera application device of the present invention showing the camera component in accordance with the disclosed architecture;

FIG. 4 illustrates a perspective view of one embodiment of the stovetop camera application device of the present invention showing the camera component paired with the smart device in accordance with the disclosed architecture;

FIGS. 5-7 illustrate a perspective view of one embodiment of the stovetop camera application device of the present invention showing the camera component secured to a bracket for mounting in accordance with the disclosed architecture;

FIGS. 8A-D illustrate a perspective view of one embodiment of the stovetop camera application device of the present invention showing the camera component in use in accordance with the disclosed architecture;

FIGS. 9A-C illustrate a perspective view of one embodiment of the stovetop camera application device of the present invention showing the camera component and paired software application in accordance with the disclosed architecture; and

FIG. 10 illustrates a flowchart showing the method of remotely monitoring items being cooked on a stovetop in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a stovetop camera application device that allows a user to virtually watch cookware on a stove. There is also a long-felt need in the art for a stovetop camera application device that utilizes a corresponding software application to watch cookware on a stove and receive notifications. Further, there is a long-felt need in the art for a stovetop camera application device that includes a heat-resistant camera with a wide-angle lens and brackets for mounting the camera. Moreover, there is a long-felt need in the art for a device that includes sensors to detect methane gas or smoke and send alerts. Further, there is a long-felt need in the art for a stovetop camera application device that includes a customizable software application which allows a user to set alarms for flame detection, steam alerts, and boiling notifications. Finally, there is a long-felt need in the art for a stovetop camera application device that includes timers to enhance functionality and safety.

The present invention, in one exemplary embodiment, is a novel stovetop camera application device. The stovetop camera application device comprises a heat-resistant camera component with a wide-angle lens that operates in a normal image mode or a heat camera mode. The camera component is installed above a stovetop hood or is wall mounted via magnets and angled brackets. The camera component includes sensors to detect methane gas or smoke. The corresponding software application has customizable features, such as alarms for flame detection, steam alerts, boiling notifications, and timers to enhance functionality and safety. The present invention also includes a novel method of remotely monitoring items being cooked on a stovetop. The method includes the steps of providing a stovetop camera application device comprising a camera component with a corresponding software application. The method also comprises mounting the camera component above a stovetop for use. Further, the method comprises pairing a smart device with the camera component. The method also comprises remotely monitoring items being cooked on the stovetop via the smart device. Finally, the method comprises receiving notifications and alerts via the paired smart device of flame detection, steam alerts, boiling notifications, and timers.

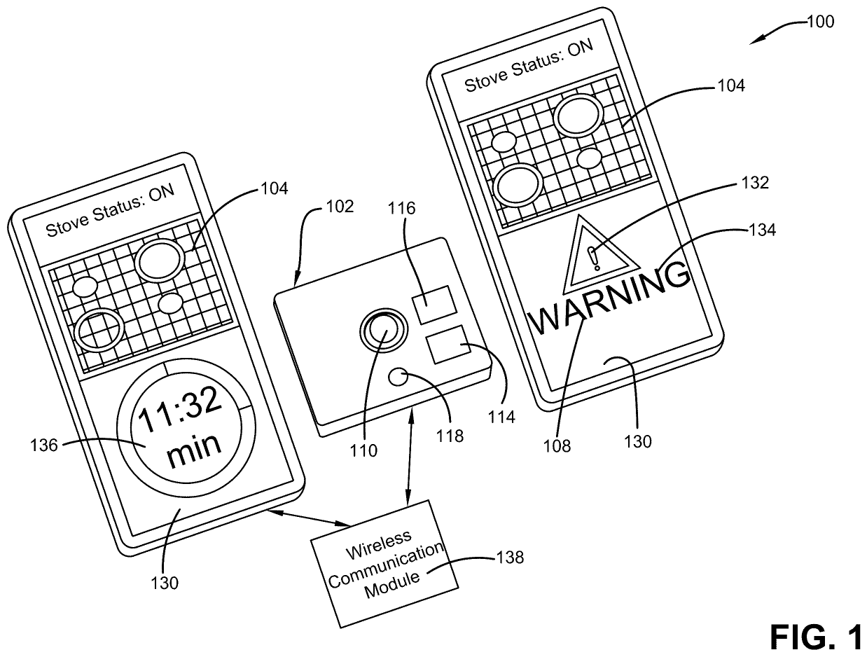

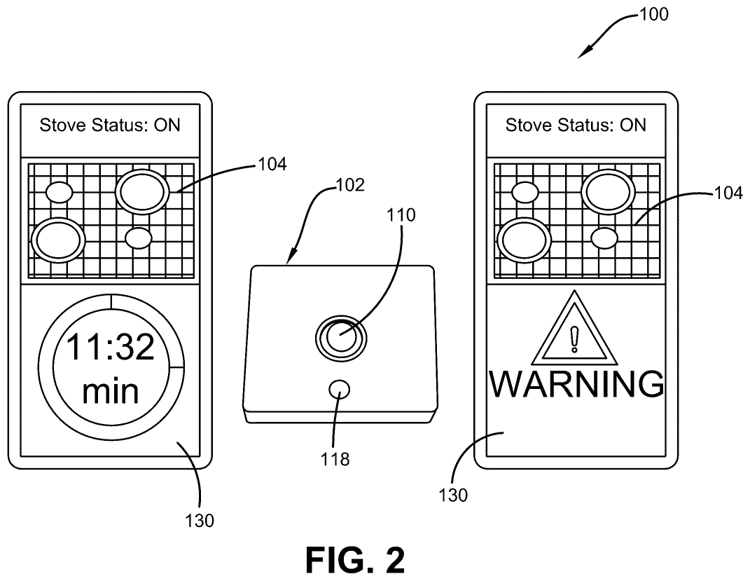

Referring initially to the drawings, FIGS. 1-2 illustrate a perspective view of one embodiment of the stovetop camera application device 100 of the present invention. In the present embodiment, the stovetop camera application device 100 is an improved stovetop camera application device 100 that provides a user with a stovetop Wi-Fi enabled camera system and corresponding software application. Specifically, the stovetop camera application device 100 comprises a camera component 102 and a corresponding software application 104. The camera component 102 is installed above a stovetop 106 and includes multiple sensors. The corresponding software application 104 has customizable features.

Generally, the stovetop camera application device 100 allows for remote viewing of the kitchen from anywhere in the house via a convenient linked app 104. A watched pot never boils, and waiting around for it wastes time too. The stovetop camera application device 100 makes it simple to monitor the state of the stovetop 106, via the paired camera component 102 and sensors with multiple wireless streaming options.

In one embodiment, the stovetop camera application device 100 comprises a plurality of indicia 108. The camera component 102 of the device 100 may include advertising, a trademark, or other letters, designs, or characters, printed, painted, stamped, or integrated into the camera component 102, or any other indicia 108 as is known in the art. Specifically, any suitable indicia 108 as is known in the art can be included, such as, but not limited to, patterns, logos, emblems, images, symbols, designs, letters, words, characters, animals, advertisements, brands, etc., that may or may not be stovetop, camera, or brand related.

Further, the camera component 102 is powered by a rechargeable battery and can be recharged via a charge port 140. In another embodiment, the camera component 102 is powered by a replaceable battery, which is replaced, as needed.

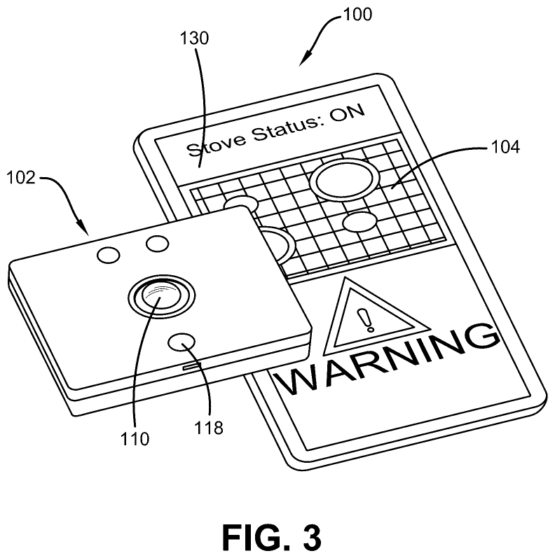

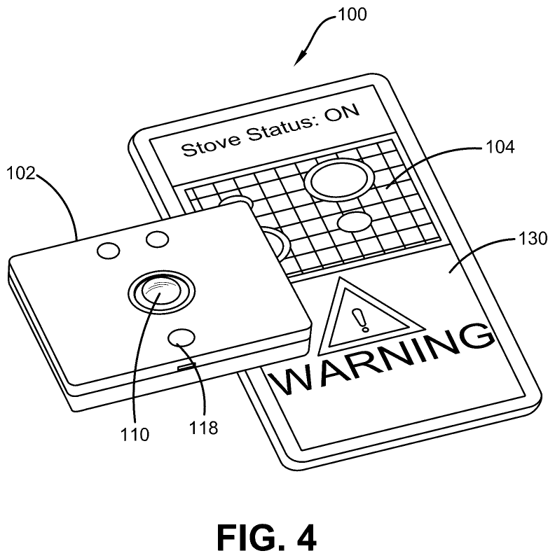

As shown in FIGS. 3-4, the stovetop camera application device 100 comprises a heat-resistant camera component 102 with a wide-angle lens 110 that keeps the whole cooktop 106 in view. The camera component 102 can be a standard, off-the-shelf camera component and can be equipped with a light which is triggered when the ambient light is less than a threshold. Typically, the camera component 102 is a heat-resistant camera, such as a thermal and/or infrared camera, which obtains thermal images, but can be any suitable camera as is known in the art.

Further, the camera component 102 includes a clear adhesive camera protector 112. The clear adhesive camera protector 112 is secured over the wide-angle lens 110 and the front of the camera component 102 to protect it from splashes, steam, moisture, and condensation from the food cooking on the stovetop 106. The clear adhesive camera protector 112 is similar to a screen protector for a smartphone and can be applied and replaced with a new protector 112 as needed.

Additionally, the camera component 102 can be operated in two different modes, such as normal image mode and heat camera mode. The camera component 102 can be switched between the modes, as needed. The normal image mode records and sends a regular image of the food cooking on the stovetop 106 to the smartphone display. The heat camera mode records and sends a thermal image of the food cooking on the stovetop 106, showing a gradient of how hot or cold the food is on the smartphone display.

Furthermore, the camera component 102 comprises methane gas 114 and smoke 116 sensors. These sensors 114, 116 detect flames, fires, steam alerts, boiling notifications, etc., that can occur on the stovetop 106. Any other suitable sensors can be utilized as is known in the art with the camera component 102.

Further, the camera component 102 comprises a light 118, which can be tapped to illuminate the stovetop 106. The light 118 can be a standard LED bulb or any other suitable light bulb as is known in the art. Further, the light 118 can be manually activated via being tapped to illuminate, on a timer, triggered when the ambient light is less than a threshold, or activated by a motion sensor, etc.

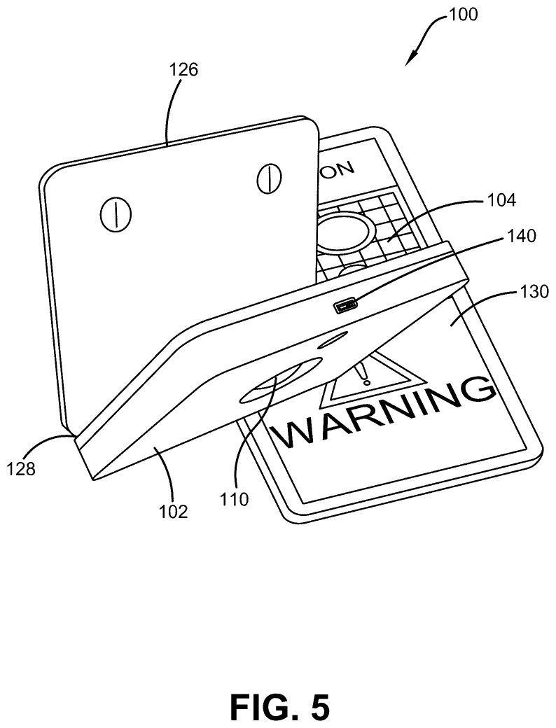

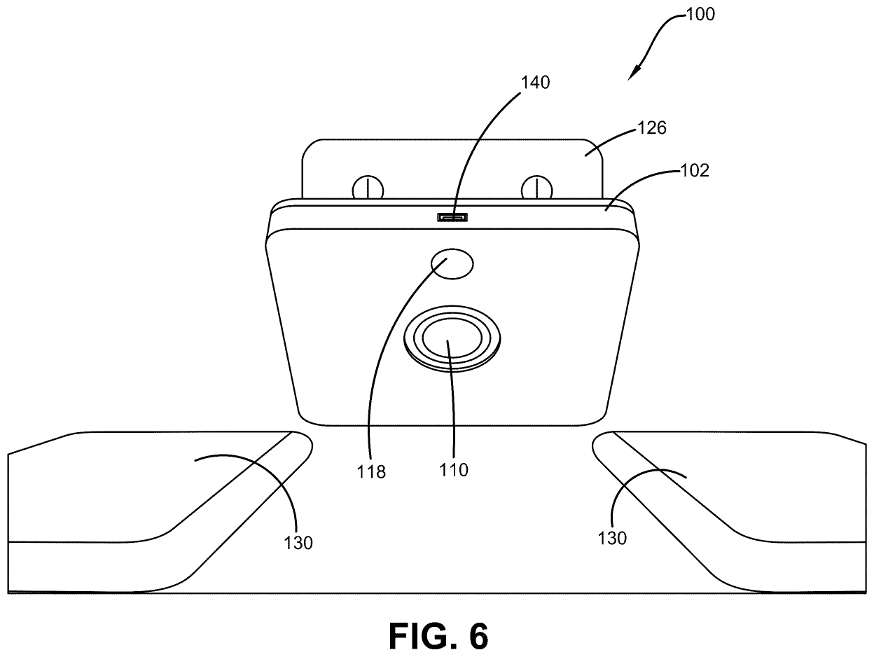

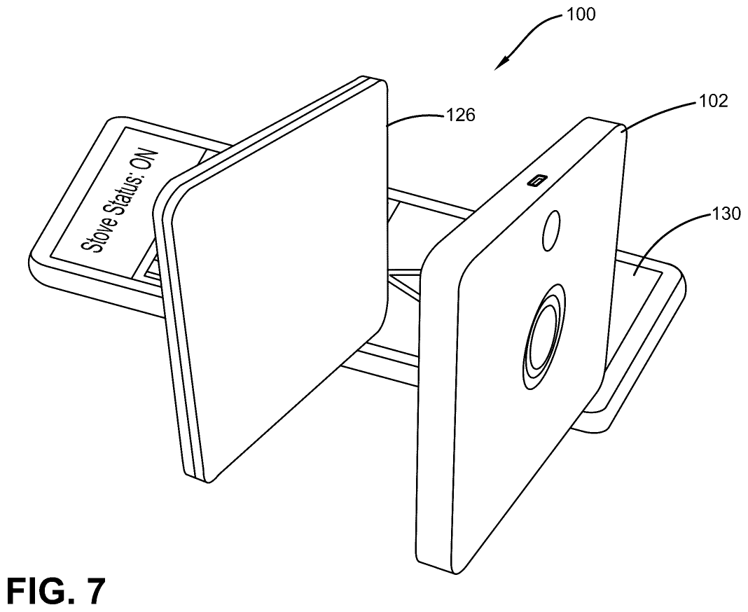

As shown in FIGS. 5-7, in one embodiment, the camera component 102 is mounted above the stovetop 106 or directly near it and angled in such a way that the stovetop 106 can be viewed via the camera component 102 and its wide-angle lens 110. Further, the camera component 102 can be mounted on the stove hood 120 or on the wall 122 behind the stovetop 106. Specifically, the camera component 102 can be mounted directly to an underside of the stove hood 120 via magnets 124 or adhesive, or any other suitable releasably securing means as is known in the art. Further, the camera component 102 is mounted directly above the stovetop 102 against a wall 122 via a mounting bracket 126. The mounting bracket 126 is an L-shaped bracket with the bracket coupled together via a hinge 128. Specifically, the mounting bracket 126 would be secured to a wall 122 via double sided tape, adhesive, or screws, etc., or any other suitable securing means as is known in the art. The camera component 102 is then secured to the mounting bracket 126 via magnets 124 or adhesive, etc., or any other suitable releasably securing means as is known in the art. Further, the hinge 128 of the mounting bracket 126 can click to a specific angle and is easily adjusted to various angles and then holds the camera component 102 at that angle, such that the camera component 102 can view the entire stovetop 106 with its wide-angle lens 110.

Of course, the number, placement, and coverage area of the camera component 102 will usually vary depending on such factors as the size and location of the stovetop 106, the size of the stove hood 120, the location of windows, and the surrounding area etc.

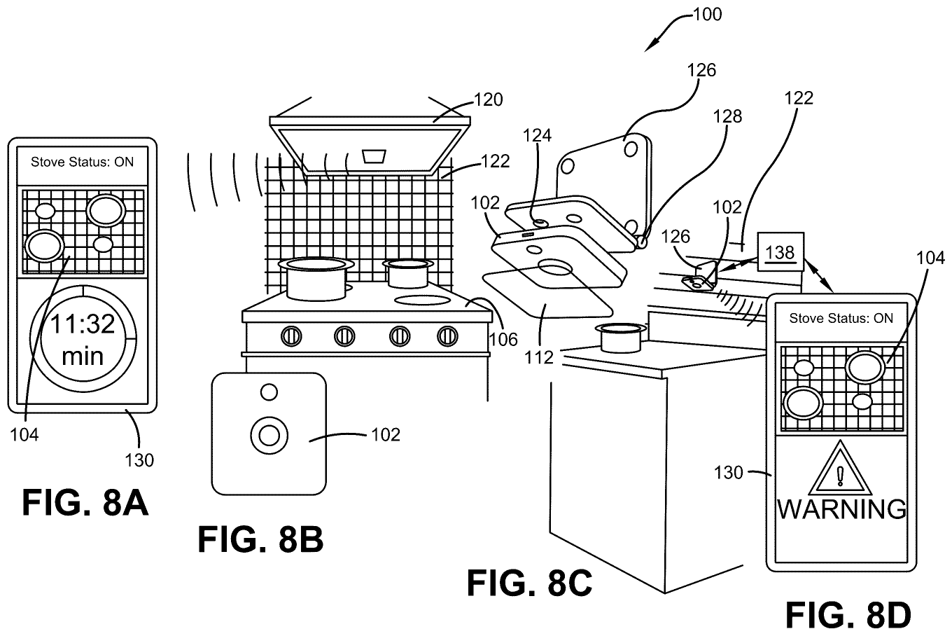

As shown in FIGS. 8A-D and 9A-C, the stovetop camera application device 100 pairs with a user's smartphone 130 via Wi-Fi or Bluetooth, or other wireless streaming options, notifying users and providing them with a livestream video feed of the stovetop 106. Specifically, the stovetop camera application device 100 comprises a software application 104 which is utilized by a user to control the device 100. Thus, the device 100 is designed to be controlled by and/or provide data to a handheld telecommunications unit, such as a smartphone 130 through the software application 104. Users can use the software application 104 to view a livestream video feed of the stovetop 106, send notifications, and/or receive alerts, etc. Specifically, the software application 104 can have customizable features, such as alarms 132 for flame detection, steam alerts 134, boiling notifications, and timers 136 to enhance functionality and safety, etc., and any other suitable alerts and/or notifications as is known in the art.

Further, the stovetop camera application device 100 includes a wireless communications module 138 and additional sensors, which would allow the device 100 to pair with the software application 104 on the smart device 130. Once paired, a user could control the stovetop camera application device 100 via the software application 104. In one embodiment, the smart device 130 may be a smartphone, a tablet, a laptop, or a desktop computer, etc., or any other suitable electronic device that has the required operating and memory parameters to support the software application 104 of the present invention and may be connected to the internet. The smart device 130 may perform any type of wireless communication, including, but not limited to, WIFI, BLUETOOTH, RFID, NFC, etc.

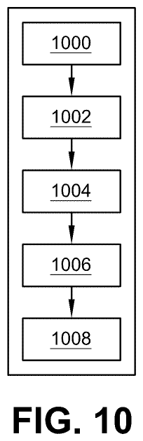

FIG. 10 illustrates a flowchart of the method of remotely monitoring items being cooked on a stovetop. The method includes the steps of at 1000, providing a stovetop camera application device comprising a camera component with a corresponding software application. The method also comprises at 1002, mounting the camera component above a stovetop for use. Further, the method comprises at 1004, pairing a smart device with the camera component. The method also comprises at 1006, remotely monitoring items being cooked on the stovetop via the smart device. Finally, the method comprises at 1008, receiving notifications and alerts via the paired smart device of flame detection, steam alerts, boiling notifications, and timers.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “stovetop camera application device”, “stovetop device”, “camera device”, and “device” are interchangeable and refer to the stovetop camera application device 100 of the present invention.

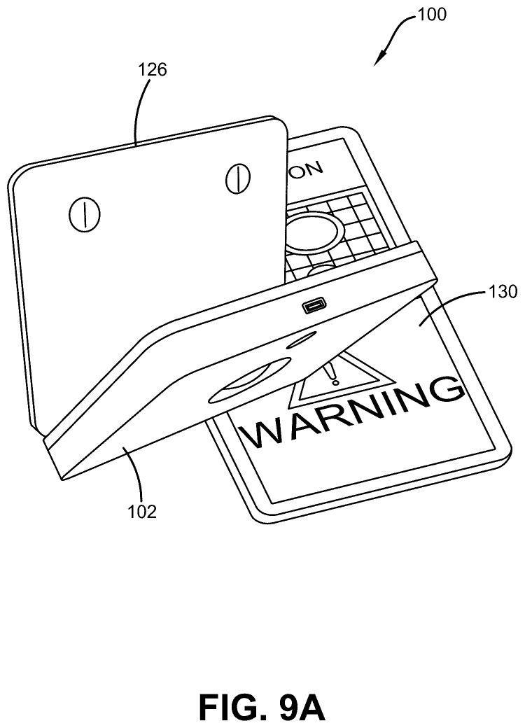

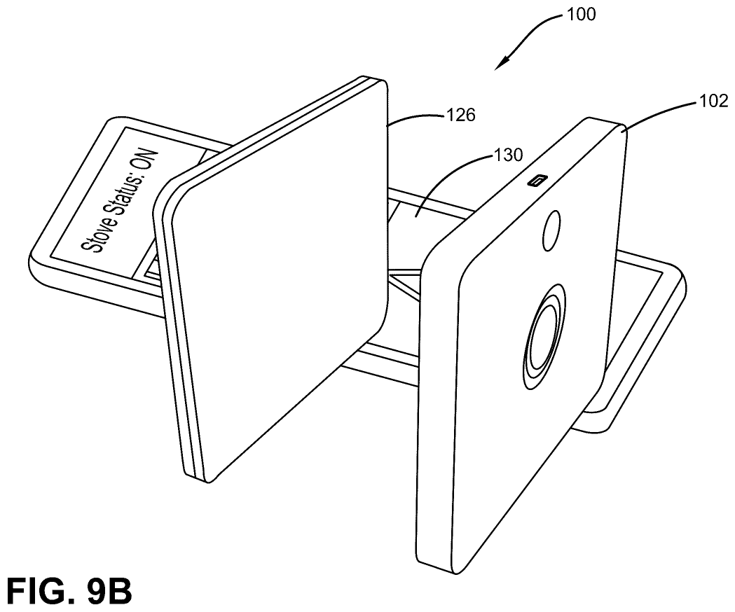

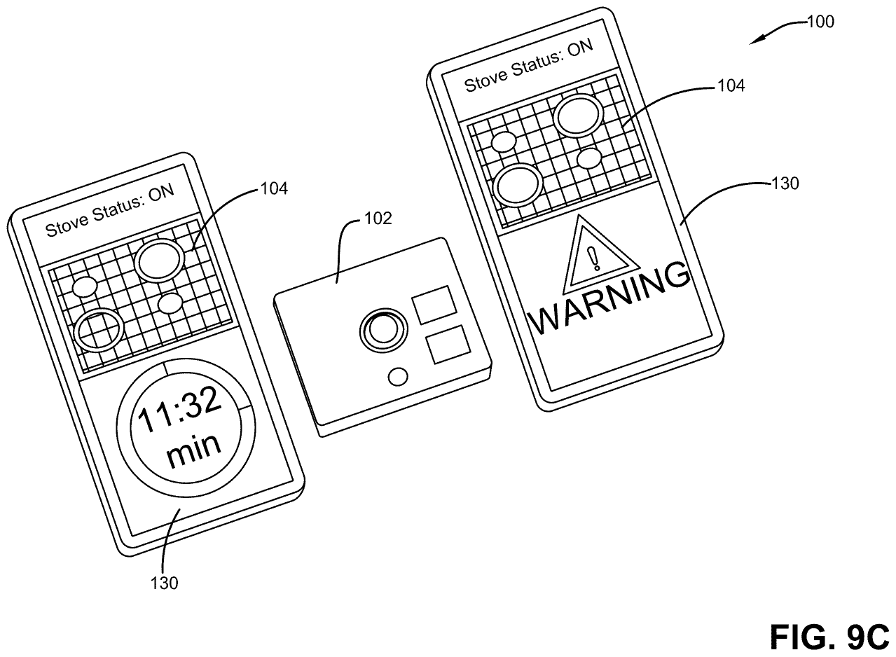

Notwithstanding the foregoing, the stovetop camera application device 100 of the present invention can be of any suitable size and configuration as is known in the art without affecting the overall concept of the invention, provided that it accomplishes the above-stated objectives. One of ordinary skill in the art will appreciate that the stovetop camera application device 100 as shown in FIGS. 1-10 is for illustrative purposes only, and that many other sizes and shapes of the stovetop camera application device 100 are well within the scope of the present disclosure. Although the dimensions of the stovetop camera application device 100 are important design parameters for user convenience, the stovetop camera application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A stovetop camera application device that allows a user to remotely monitor food cooking on a stovetop, the stovetop camera application device comprising:
a camera component; and
a software application on a smart device;
wherein the camera component is mounted directly above a stovetop; and
further wherein the camera component transmits images to the software application, such that a user can watch food cooking on a stovetop from anywhere in a home.

2. The stovetop camera application device of claim 1 further comprising a plurality of indicia.

3. The stovetop camera application device of claim 2, wherein the camera component is a heat-resistant camera component with a wide-angle lens that keeps whole cooktop in view.

4. The stovetop camera application device of claim 3, wherein the camera component includes a clear adhesive camera protector that is secured over the wide-angle lens and a front of the camera component to protect it.

5. The stovetop camera application device of claim 4, wherein the camera component can be operated in two different modes, such as normal image mode and heat camera mode.

6. The stovetop camera application device of claim 5, wherein the normal image mode records and sends a regular image of food cooking on the stovetop to the smart device and the heat camera mode records and sends a thermal image of the food cooking on the stovetop, showing a gradient of how hot or cold the food is on the smart device.

7. The stovetop camera application device of claim 6, wherein the camera component comprises methane gas and smoke sensors.

8. The stovetop camera application device of claim 7, wherein the camera component comprises a light, which can be tapped to illuminate the stovetop.

9. The stovetop camera application device of claim 8, wherein the camera component is mounted directly to an underside of the stove hood via magnets or adhesive.

10. The stovetop camera application device of claim 8, wherein the camera component is mounted directly above the stovetop against a wall via a mounting bracket.

11. The stovetop camera application device of claim 10, wherein the mounting bracket is an L-shaped bracket coupled together via a hinge that allows the camera component to be locked into a specific angle.

12. The stovetop camera application device of claim 11, wherein the stovetop camera application device pairs with a user's smart device via Wi-Fi or Bluetooth, or other wireless streaming options, notifying users and providing them with a livestream video feed of the stovetop.

13. The stovetop camera application device of claim 12, wherein users utilize the software application on the smart device to view a livestream video feed of the stovetop, send notifications or receive alerts, and set alarms or timers.

14. A stovetop camera application device that allows a user to remotely monitor food cooking on a stovetop, the stovetop camera application device comprising:
a camera component that is a heat-resistant camera component with a wide-angle lens that keeps whole cooktop in view; and
a software application on a smart device;
wherein the camera component includes a clear adhesive camera protector that is secured over the wide-angle lens and a front of the camera component to protect it;
wherein the camera component can be operated in two different modes, such as normal image mode and heat camera mode;
wherein the camera component comprises methane gas and smoke sensors;
wherein the camera component comprises a light, which can be tapped to illuminate the stovetop;
wherein the camera component is mounted directly to an underside of the stove hood via magnets or adhesive;
wherein the camera component is mounted directly above the stovetop against a wall via a mounting bracket;
wherein the stovetop camera application device pairs with a user's smart device via Wi-Fi or Bluetooth, or other wireless streaming options, notifying users and providing them with a livestream video feed of the stovetop via the software application; and
further wherein users utilize the software application on the smart device to view a livestream video feed of the stovetop, send notifications or receive alerts, and set alarms or timers.

15. The stovetop camera application device of claim 14, wherein the camera component includes a wireless communications module and additional sensors which would allow the stovetop camera application device to pair with the software application on the smart device.

16. The stovetop camera application device of claim 15, wherein the smart device may be a smartphone, a tablet, a laptop or a desktop computer.

17. The stovetop camera application device of claim 14, wherein the mounting bracket would be secured to a wall via double sided tape, adhesive, or screws.

18. The stovetop camera application device of claim 17, wherein the camera component is then secured to the mounting bracket via magnets or adhesive.

19. The stovetop camera application device of claim 14, wherein the software application has customizable features, such as alarms for flame detection, steam alerts, boiling notifications, and timers to enhance functionality and safety.

20. A method of remotely monitoring items being cooked on a stovetop, the method comprising the following steps:
providing a stovetop camera application device comprising a camera component with a corresponding software application;
mounting the camera component above a stovetop for use;
pairing a smart device with the camera component;
remotely monitoring items being cooked on the stovetop via the smart device; and
receiving notifications and alerts via the paired smart device of flame detection, steam alerts, boiling notifications, and timers.
